(19) United States
(12) Patent Application Publication
(10) Pub. No.: US 2014/0058591 A1
(43) Pub. Date: Feb. 27, 2014

(54) METHOD FOR PROVIDING FLIGHT DATA

(71) Applicant: GE AVIATION SYSTEMS LIMITED, Cheltenham (GB)

(72) Inventors: Steve John Schoonveld, Grand Rapids, MI (US); Stephane Laurent Petter, Cheltenham (GB)

(73) Assignee: GE AVIATION SYSTEMS LIMITED, Cheltenham (GB)

(21) Appl. No.: 13/719,869

(22) Filed: Dec. 19, 2012

(30) Foreign Application Priority Data
Aug. 22, 2012 (GB) 12149191

(51) Int. Cl. G08G 5/00

(52) U.S. Cl. CPC G08G 5/0095
USPC 701/3

(57) ABSTRACT

A method of providing real-time flight data to an aircraft, which includes the flying of a first aircraft along a flight path and obtaining real-time flight data as the first aircraft is flown along the flight path. The method includes directly relaying at least a portion of the real-time flight data.

### CROSS-REFERENCE TO RELATED APPLICATIONS

This application claims priority under 35 U.S.C. §119 to British Patent Application No. 12149191, filed Aug. 22, 2012, the disclosure of which is incorporated herein by reference in its entirety.

### BACKGROUND OF THE INVENTION

In contemporary aircraft, numerous data may be considered for determining desired altitudes, determining suitable waypoints, estimating time of arrival and fuel burned during an aircraft's flight, etc. This data is often provided to the flight management system (“FMS”) before the aircraft takes off and may become stale during flight. Such contemporary aircraft may also rely on information gathered by their own sensing equipment. However, such information is only used by the aircraft that gathered it and provides no additional benefit unless a crew member unilaterally calls in the information to a flight control. In such an instance, flight control may then ad hoc determine if the information is important and may disseminate the information accordingly. The current approach of using unilaterally provided information with an ad hoc distribution is not effective at disseminating relevant information.

### BRIEF DESCRIPTION OF THE INVENTION

In one embodiment, the invention relates to a method of providing real-time flight data to an aircraft including, flying a first aircraft along a flight path, obtaining real-time flight data as the first aircraft is flown along the flight path, and directly relaying at least a portion of the real-time flight data to a second aircraft flying at least a portion of the flight path.

### BRIEF DESCRIPTION OF THE DRAWINGS

In the drawings:

FIG. 1 is a schematic illustration of an aircraft providing information to another aircraft according to one embodiment of the invention.

FIG. 2 is a schematic illustration of the aircraft of FIG. 1 providing information to a ground system and an additional aircraft according to another embodiment of the invention.

FIG. 3 is a flow chart illustrating a method for transmitting flight data between the aircraft of FIG. 1 according to yet another embodiment of the invention.

### DETAILED DESCRIPTION OF THE INVENTION

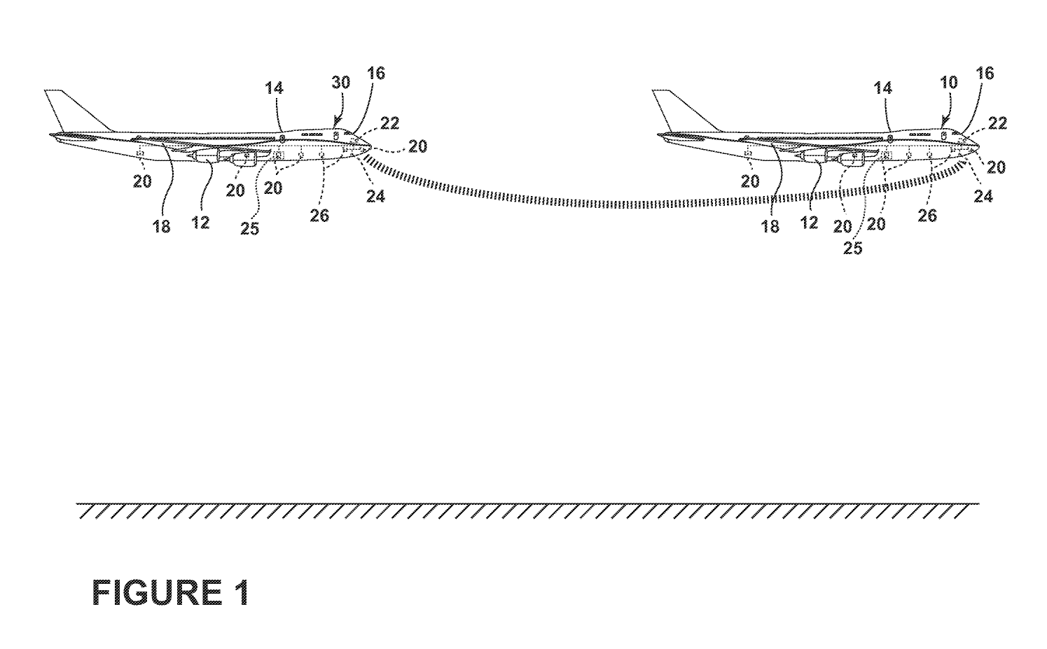

FIG. 1 depicts a first aircraft 10 that may execute embodiments of the invention and may include one or more propulsion engines 12 coupled to a fuselage 14, a cockpit 16 positioned in the fuselage 14, and wing assemblies 18 extending outward from the fuselage 14. A plurality of aircraft systems 20 that enable proper operation of the first aircraft 10 may be included as well as a flight control computer 22, and a communication system having a wireless communication link 24. While a commercial aircraft has been illustrated, it is contemplated that embodiments of the invention may be used in any type of legacy aircraft, for example, without limitation, fixed-wing, rotating-wing, rocket, personal aircraft, and military aircraft.

The plurality of aircraft systems 20 may reside within the cockpit 16, within the electronics and equipment bay 25, or in other locations throughout the aircraft 10 including that they may be associated with the engines 12. Such aircraft systems 20 may include but are not limited to: an electrical system, an oxygen system, hydraulics and/or pneumatics system, a fuel system, a propulsion system, navigation systems, flight controls, audio/video systems, an Integrated Vehicle Health Management (IVHM) system, Onboard Maintenance System, Central Maintenance Computer and systems associated with the mechanical structure of the first aircraft 10. A variety of aircraft systems 20 have been illustrated for exemplary purposes and it will be understood that they are only a few of the systems that may be included in the first aircraft 10.

The flight control computer 22, which may include a flight management computer, may among other things, automate the tasks of piloting and tracking the flight plan of the first aircraft 10. The flight control computer 22 may include or be associated with, any suitable number of individual microprocessors, power supplies, storage devices, interface cards, auto flight systems, flight management computers, and other standard components. The flight control computer 22 may include or cooperate with any number of software programs (e.g., flight management programs) or instructions designed to carry out the various methods, process tasks, calculations, and control/display functions necessary for operation of the first aircraft 10. The flight control computer 22 is illustrated as being in communication with the plurality of aircraft systems 20 and it is contemplated that the flight control computer 22 may aid in operating the aircraft systems 20 and may send and receive information from the aircraft systems 20.

The wireless communication link 24 may be communicably coupled to the flight control computer 22 or other processors of the aircraft to transfer flight data off the first aircraft 10. Such a wireless communication link 24 may be any variety of communication mechanism capable of wirelessly linking with other systems and devices and may include, but is not limited to, packet radio, satellite uplink, Wireless Fidelity (WiFi), WiMax, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof It will also be understood that the particular type or mode of wireless communication is not critical to this invention, and later-developed wireless networks are certainly contemplated as within the scope of this invention. Further, the wireless communication link 24 may be communicably coupled with the flight control computer 22 through a wired link without changing the scope of this invention. Although only one wireless communication link 24 has been illustrated it is contemplated that the first aircraft 10 may have multiple wireless communication links communicably coupled with the flight control computer or other onboard computing device receiving flight information 22. Such multiple wireless communication links may provide the first aircraft 10 with the ability to transfer flight data off the first aircraft 10 in a variety of ways such as by satellite, GSM, and WiFi.

Further, one or more sensors 26 may be provided on or within the aircraft to obtain real-time flight data. Such sensors 26 may be operably coupled to the flight control computer 22 or another controller onboard the first aircraft 10 to provide the first aircraft 10 within such real-time flight data. It is also contemplated that such sensors 26 may be operably coupled with the wireless communication link 24 to allow the information obtained by the sensors 26 to be relayed off the first aircraft 10, such as to a second aircraft 30, without the flight control computer 22.

The one or more sensors 26 may be capable of sensing and providing both environmental and aircraft data. For example, the one or more sensors 26 may be capable of sensing, among other environmental data, weather data including temperature, pressure, real winds aloft, relative humidity, icing, and turbulence data. The sensors 26 may also be capable of integrating such information with coordinates where the data was obtained as well as a time stamp of when such information was obtained. Further, the one or more sensors 26 may be capable of sensing, among other aircraft data, data from all substantial aircraft systems including the braking hydraulics, speeds and performance parameters including deceleration data, acceleration data, landing performance data, take-off performance data, derated thrust data, runway condition parameters, aircraft weight and/or class, attitude and location, and fuel temperature. Alternatively, such aircraft data may be obtained from the aircraft systems 20 and relayed off the first aircraft 10.

During operation, the flight control computer 22 may receive information from the aircraft systems 20 and/or the one or more sensors 26. The flight control computer 22 may execute a program for transmitting the real-time flight data from the first aircraft 10 to a second aircraft 30, which may be similarly equipped with a wireless communication link 24. Alternatively, a separate module or computer may execute a program for transmitting the real-time flight data from the first aircraft 10 to the second aircraft 30. The process may be implemented automatically by the flight control computer 22 or the separate module or computer when the first aircraft 10 is in flight and requires no crew involvement.

For example, the flight control computer 22 may run a program for transmitting the real-time flight data. The program may include a computer program product that may include machine-readable media for carrying or having machine-executable instructions or data structures stored thereon. Such machine-readable media may be any available media, which can be accessed by a general purpose or special purpose computer or other machine with a processor. Embodiments of the invention will be described in the general context of a method that may be implemented in one embodiment by a program product including machine-executable instructions, such as program code, for example, in the form of program modules. Generally, program modules include routines, programs, objects, components, data structures, algorithms, etc. that have the technical effect of performing particular tasks or implement particular abstract data types. Machine-executable instructions, associated data structures, and program modules represent examples of program code for executing the method disclosed herein. Machine-executable instructions may include, for example, instructions and data, which cause a general purpose computer, special purpose computer, or special purpose processing machine to perform a certain function or group of functions.

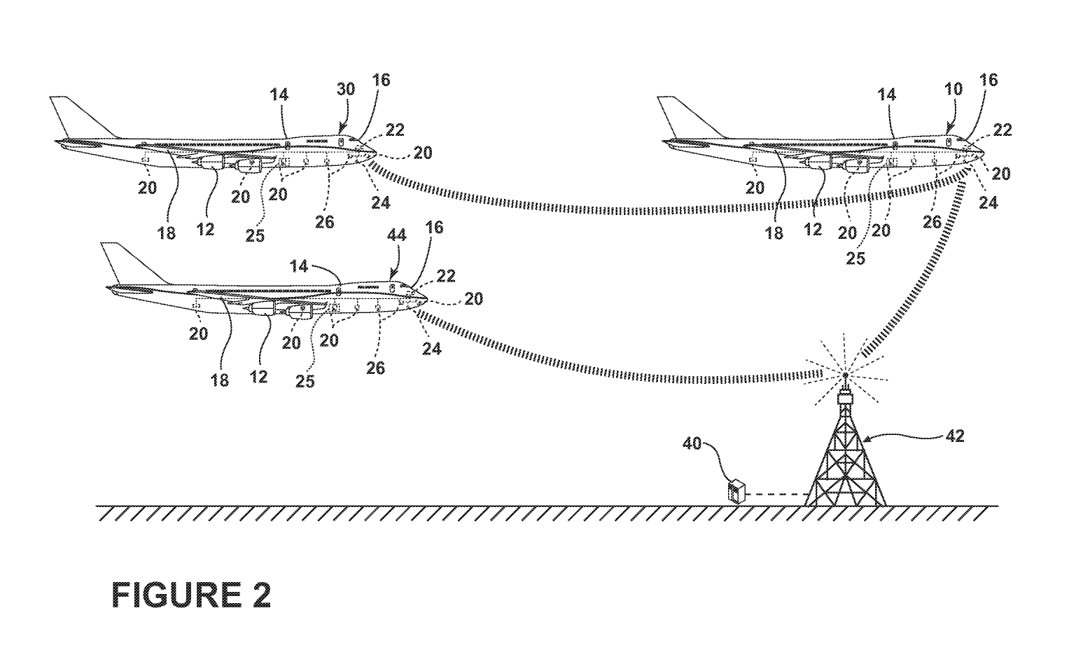

The transmission of real-time flight data as illustrated in FIG. 1 is directly between two aircraft. The transmission may occur as long as the two aircraft are within the range of the wireless communication link 24. Additionally, the real-time flight data may be relayed through another communication link, which may or may not be wireless, such as a ground system. Referring now to FIG. 2, the flight control computer 22 may also communicate with a computer or destination server 40, which may be located at and include a designated ground system 42 via the wireless communication link 24. The ground system 42 may be any type of communicating ground system 42 such as an airline operations center. In general, the wireless communication link 24 may have limited bandwidth available for transmitting extensive data from the first aircraft 10, and, in any event, it may be costly to communicate large amounts of data via the wireless communication link 24 to the designated ground system 42. Thus, it is contemplated that information and its transfer may be prioritized by the first aircraft 10 such that information is relayed first to the ground system 42 and second to second aircraft 30.

During operation, the flight control computer 22 may receive information from the aircraft systems 20 and/or the one or more sensors 26. The flight control computer 22 may execute a program for transmitting the real-time flight data from the first aircraft 10 to the second aircraft 30 and the ground system 42. Alternatively, a separate module or computer may execute a program for transmitting the real-time flight data in its raw form or transmit a derived set of information. The process may be implemented automatically by the flight control computer 22 when the first aircraft 10 is in flight and requires no crew involvement.

It is contemplated that after the real-time flight data is relayed it may be processed either by the second aircraft 30 or by the ground system 42. Processing the real-time flight data may include aggregating the real-time flight data with other obtained real-time flight data and/or other data not obtained during flight. Such aggregated data may then be transmitted to the second aircraft 30, to the another aircraft, such as the illustrated another aircraft 44, or to another ground station (not shown). The another aircraft 44 may either be of a same airline as the first aircraft 10 or a different airline and the another aircraft 44 may be flying along the same flight path as the first aircraft 10 or not. It is also contemplated that the real-time information may be relayed through multiple additional aircraft from either the second aircraft 30 or the ground system 42. Further, the real-time flight data may be stored in a system that is accessible by the airline operating the first aircraft 10 and/or by other airlines. In this manner, the data may be aggregated across multiple aircraft to build a more accurate picture of the flight environmental conditions, thus contributing to improving flight performance. Data may also be aggregated across different airlines or carriers to build a comprehensive source of information that may then be shared.

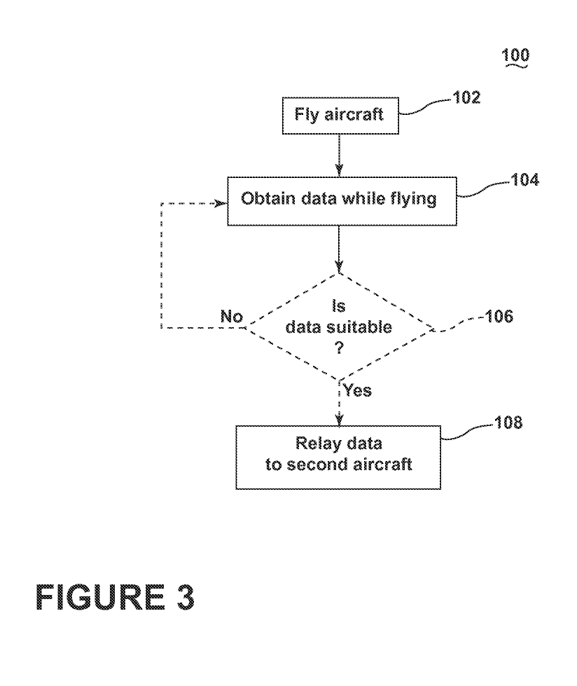

Embodiments of the invention include transmitting real-time flight data for the first aircraft 10 to at least a second aircraft 30 via the wireless communication link 24. In accordance with an embodiment of the invention, FIG. 3 illustrates a method 100, which may be used for transmitting the real-time flight data. The method 100 includes flying the aircraft at 102, obtaining real-time flight data at 104, optionally determining a suitability of the information at 106, and transmitting the real-time flight data to the second aircraft 30 at 108.

The method 100 begins at 102 with flying the first aircraft 10 along a flight path. The term flying may include all portions of the flight including portions where the first aircraft 10 is not in the air such as during takeoff, landing, and taxiing. Real-time flight data may be obtained while the aircraft is flying at 104. Including that the real-time flight data may be obtained during at least one phase of the flight path. By way of example, the at least one phase where the real-time flight data may be obtained may be at least one of: take off, climb, cruise, descent, landing, and taxiing. Real-time flight data may also be obtained during multiple phases including any combination of such multiple phases. The real-time flight data obtained may include any information obtained by the one or more sensors 26 and/or the aircraft systems 20.

It is contemplated that the real-time flight data may be processed before the real-time flight data is relayed. The real-time flight data may be processed in any suitable manner including that the real-time flight data may be filtered or corrected with a correction value before being relayed. As another example, at 106 the method optionally includes determining whether the real-time data is suitable to be transferred. The suitability of the real-time flight data may be determined based on at least one suitability criteria. By way of non-limiting examples, such suitability criteria may include a time criteria and a geography criteria. For example, the real-time flight data may have an expiration time of less than 8 hours. By way of further example, the real-time flight data such as turbulence data may have an expiration time of two hours. The geography criteria may limit information from being relayed if the second aircraft is not being flown on the same flight path as the first aircraft 10 at that particular location. In this manner, the suitability criteria may be used to ensure that only pertinent data is transferred.

At 108, at least a portion of the real-time flight data obtained at 104 may be directly relayed to the second aircraft 30 flying at least a portion of the flight path. The real-time flight data may be considered to be directly relayed regardless of whether some processing of the information occurs in the first aircraft 10. The second aircraft 30 may receive and process the real-time flight data or communicate the real-time flight data to the flight deck to be incorporated into the flight plan by pilot decision. In this manner, the real-time flight data may enable the flight optimization of the second aircraft 30.

It will be understood that the method of transmitting real-time flight data is flexible and that the method 100 illustrated is merely for illustrative purposes. For example, at least a portion of the real-time flight data may be relayed to a second aircraft flying at least a portion of the flight path regardless of whether the data is determined to be suitable. Furthermore, at least a portion of the real-time flight data may be relayed to a second aircraft without any determination regarding the suitability of the real-time flight data being made. Additionally, real-time flight data may be relayed only to the ground system such that it can be used to route aircraft around a particular area. For example, turbulence data may be relayed to the ground where it is used in the airline operations center to plan flights such that they avoid the area of turbulence. It is contemplated that the obtaining and relaying of the real-time flight data may be done at predetermined time intervals or continuously.

Technical effects of the above described embodiments include that data gathered by the aircraft during flight may be transferred to another aircraft sharing a portion of the flight path flown by the first aircraft. Currently aircraft rely on the information gathered by their own sensing equipment and there is no mechanism in place by which they can benefit from the acquisition of information by other aircraft that have flown a similar flight path or taken-off or landed on the same tarmac. The above described embodiments use real-time flight and environmental data from in-flight aircraft to enable the flight optimization of subsequent flying aircraft. The above described embodiments may result in many benefits including improved flight performance, which can have a positive impact on both operating costs and safety. For example, any improved flight path can result in reduced fuel burn which is the greatest individual cost for airlines.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of providing real-time flight data to an aircraft, the method comprising:
flying a first aircraft along a flight path;
obtaining real-time flight data as the first aircraft is flown along the flight path; and
directly relaying at least a portion of the real-time flight data to a second aircraft flying at least a portion of the flight path.

2. The method of claim 1 wherein the real-time flight data is obtained during at least one phase of the flight path.

3. The method of claim 2 wherein the at least one phase comprises at least one of: take off, climb, cruise, descent, landing, and taxiing.

4. The method of claim 1, further comprising processing the real-time flight data before relaying the real-time flight data.

5. The method of claim 4 wherein the processing comprises determining a suitability of the real-time flight data based on at least one suitability criteria.

6. The method of claim 5 wherein the suitability criteria includes at least one of time and geography.

7. The method of claim 1 wherein the real-time flight data is relayed to a ground system.

8. The method of claim 7, further comprising processing the real-time flight data after it is relayed.

9. The method of claim 8 wherein the processing the real-time flight data includes aggregating the real-time flight data.

10. The method of claim 9 wherein the aggregated data is transmitted to another aircraft.

11. The method of claim 10 wherein the another aircraft is of a same airline as the first aircraft flown.

12. The method of claim 10 wherein the another aircraft is flying along the flight path.

13. The method of claim 8, further comprising storing the real-time flight data in a system that is accessible by other airlines.

14. The method of claim 1, further comprising transmitting the real-time flight data to another aircraft.

15. The method of claim 1 wherein the real-time flight data includes weather data comprising at least one of icing data, turbulence data, and real winds aloft data.

16. The method of claim 1 wherein the real-time flight data has an expiration time of less than 8 hours.
